(19) United States
(12) Patent Application Publication
(10) Pub. No.: US 2017/0147355 A1
(43) Pub. Date: May 25, 2017

(54) METHOD AND SYSTEM FOR ACCELERATING INTELLIGENT TERMINAL BOOT SPEED

(71) Applicants: Le Holdings (Beijing) Co., Ltd., Beijing (CN); Lemobile Information Technology (Beijing) Co., Ltd., Beijing (CN)

(72) Inventors: Shufeng REN, Beijing (CN); Guofeng XIE, Beijing (CN)

(21) Appl. No.: 15/242,389

(22) Filed: Aug. 19, 2016

Related U.S. Application Data
(63) Continuation of application No. PCT/CN2016/083639, filed on May 27, 2016.

(30) Foreign Application Priority Data
Nov. 24, 2015 (CN) 201510824922.9
May 27, 2016 (CN) PCT/CN2016/083639

(51) Int. Cl. G06F 9/44; G06F 1/32; G06F 13/40

(52) U.S. Cl. CPC G06F 9/4401; G06F 13/4081; G06F 13/4022; G06F 1/324

(57) ABSTRACT

The present invention provides a method and a system for accelerating intelligent terminal boot speed, wherein the method for accelerating intelligent terminal boot speed includes: defining a delay time to delay the startup of a CPU hotplug algorithm during a flow of booting for performing a CPU algorithm; setting a running mode of the CPU as a performance mode, so that the CPU is under a highest frequency state and the CPU is under a multi-core state; and switching the running mode of the CPU to a normal mode when the defined delay time terminates, so that the CPU adjusts the CPU frequency according to a normal boot load. A problem of slow boot speed of a smartphone installed with an Android system is solved by delaying the CPU algorithm, adjusting and switching the CPU mode so that the CPU is under the highest frequency and multi-core state during the boot of the intelligent terminal; meanwhile, the present invention also discloses a system for accelerating intelligent terminal boot speed, which may solve the problem of slow boot speed of the smartphone installed with an Android system similarly.

### CROSS-REFERENCE

This application is national phase application of PCT international application No. PCT/CN2016/083639, filed May 27, 2016, which claims priority to Chinese Patent Application No. 2015108249229, filed Nov. 24, 2015. The entire contents of these applications are incorporated herein by reference.

### TECHNICAL FIELD

The present invention relates to the field of intelligent terminal technologies, and more particularly, to a method and a system for accelerating intelligent terminal boot speed.

### BACKGROUND

Intelligent terminals have been used universally in the life of people in recent years, wherein a smartphone is a product form that is quickly developed in recent years and popular to users. At current, the most common smartphone is a smartphone installed with an Android system, which has an excellent operating system, and can be installed with various application softwares freely, but the boot speed of the smartphone is slow, which greatly affects the user experience. In the present solutions, no processing is conducted on a CPU algorithm during the process of booting, and it is needed to open CPU hotplug firstly by default. Moreover, the number of CPU and the frequency of CPU are limited during the process of booting, thus affecting the boot speed. Therefore, it is a very important job to study and adjust for accelerating the boot speed of a smartphone installed with the Android system.

### SUMMARY

The present invention provides a method and a system for accelerating intelligent terminal boot speed, for solving the problem of slow intelligent terminal boot speed.

The present invention provides a method for accelerating intelligent terminal boot speed, including:

defining a delay time to delay the startup of a CPU hotplug algorithm during a flow of booting for performing a CPU (central processing unit, Central Processing Unit) algorithm;

setting a running mode of the CPU as a performance mode so that the CPU is under a highest frequency state and the CPU is under a multi-core state; and

switching the running mode of the CPU to a normal mode when the defined delay time terminates, so that the CPU adjusts the CPU frequency according to a normal boot load.

Preferably, the method further includes:

calculating the time for delaying the boot of the CPU hotplug algorithm, so that the CPU dynamically adjusts the CPU frequency and the core number of the CPU according to a normal system load.

Preferably, the method, before the switching the running mode of the CPU to the normal mode when the defined delay time terminates, so that the CPU adjusts the CPU frequency according to the normal boot load, further comprises:

setting a delay time for a boot startup script.

Preferably, the defined delay time is 30 s.

Preferably, the delay time is 30 s.

The present invention further provides a system for accelerating intelligent terminal boot speed, including: a delay defining unit, a mode setting unit and a mode switching unit, wherein:

the delay defining unit is configured to define a delay time to delay the startup of a CPU hotplug algorithm during a flow of booting for performing a CPU algorithm;

the mode setting unit is configured to set a running mode of the CPU as a performance mode, so that the CPU is under a highest frequency state and the CPU is under a multi-core state; and

the mode switching unit is configured to switch the running mode of the CPU to a normal mode when the defined delay time terminates, so that the CPU adjusts the CPU frequency according to a normal boot load.

Preferably, the system further includes:

a calculation unit configured to calculate the time for delaying the boot of the CPU hotplug algorithm, so that the CPU dynamically adjusts the CPU frequency and the core number of the CPU according to a normal system load.

Preferably, the system, before the mode setting unit, further includes:

a delay setting unit configured to set a delay time for a boot startup script.

Preferably, the defined delay time is 30 s.

Preferably, the delay time is 30 s.

According to the method and the system for accelerating intelligent terminal boot speed provided by the present invention, the delay time is defined for delaying the startup of the CPU hotplug algorithm during the flow of booting for performing the CPU algorithm; the running mode of the CPU is set as a performance mode so that the CPU is under the highest frequency state and the CPU is under the multi-core state; and the running mode of the CPU is switched to the normal mode, so that the CPU adjusts the CPU frequency according to the normal boot load when the defined delay time terminates. A problem of slow boot speed of a smartphone installed with an Android system is solved by delaying the CPU algorithm, adjusting and switching the CPU mode so that the CPU is under the highest frequency and multi-core state during the boot of the intelligent terminal; meanwhile, the present invention also discloses the system for accelerating intelligent terminal boot speed, which may solve the problem of slow boot speed of the smartphone installed with an Android system similarly.

### BRIEF DESCRIPTION OF THE DRAWINGS

In order to explain the technical solutions in the embodiments of the present invention or in the prior art more clearly, the drawings used in the descriptions of the embodiments or the prior art will be simply introduced hereinafter. It is apparent that the drawings described hereinafter are merely some embodiments of the present invention, and those skilled in the art may also obtain other drawings according to these drawings without going through creative work.

FIG. 1 is a flow chart of a first embodiment of a method for accelerating intelligent terminal boot speed provided by the present invention;

FIG. 2 is a flow chart of a second embodiment of the method for accelerating intelligent terminal boot speed provided by the present invention;

FIG. 3 is a structure diagram of a first embodiment of a system for accelerating intelligent terminal boot speed provided by the present invention; and

FIG. 4 is a structure diagram of a second embodiment of the system for accelerating intelligent terminal boot speed provided by the present invention.

### DETAILED DESCRIPTION

To make the objects, technical solutions and advantages of the embodiments of the present invention more clearly, the technical solutions of the present invention will be clearly and completely described hereinafter with reference to the embodiments and drawings of the present invention. Apparently, the embodiments described are merely partial embodiments of the present invention, rather than all embodiments. Other embodiments derived by those having ordinary skills in the art on the basis of the embodiments of the present invention without going through creative efforts shall all fall within the protection scope of the present invention.

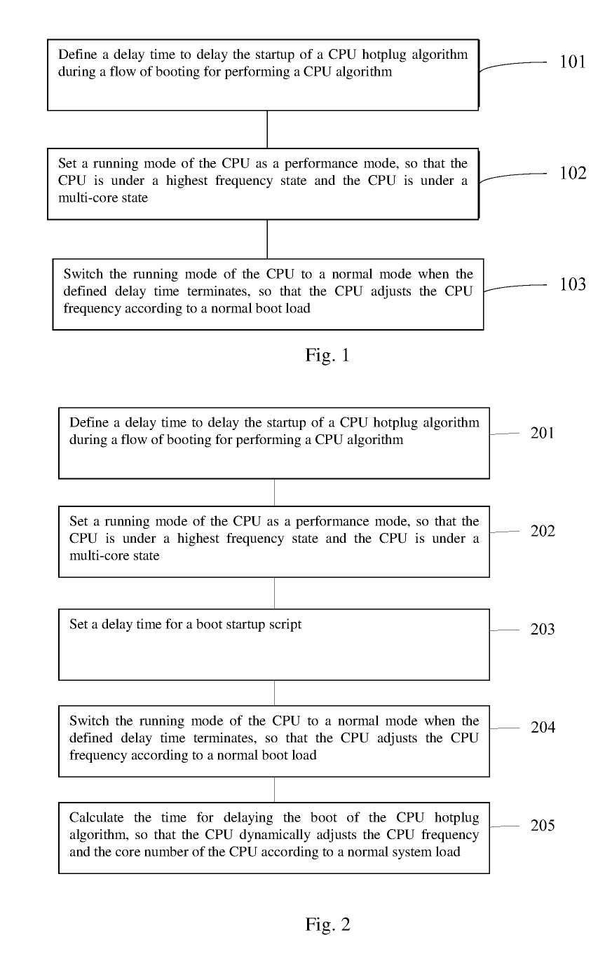

FIG. 1 is a flow chart of a first embodiment of a method for accelerating intelligent terminal boot speed provided by the present invention. As shown in FIG. 1, the method according to the embodiment may include the following steps.

In step 101, a delay time is defined to delay the startup of a CPU hotplug algorithm during a flow of booting for performing a CPU (central processing unit, Central Processing Unit) algorithm.

A CPU algorithm processed by CPU Hotplug has to be adopted in the prior art; in this way, the CPU is under a few-core low frequency state during boot, so that the boot speed is slow.

In step 102, the running mode of the CPU is set as a performance mode, so that the CPU is under a highest frequency state and the CPU is under a multi-core state.

In the prior art, the CPU is under the few-core low frequency state all the time during running process.

In step 103, the running mode of the CPU is switched to a normal mode when the defined delay time terminates, so that the CPU adjusts the CPU frequency according to a normal boot load.

According to the embodiment, a problem of slow boot speed of a smartphone installed with an Android system is solved by delaying the CPU algorithm, adjusting and switching the CPU mode so that the CPU is under the highest frequency and multi-core state during the boot of the intelligent terminal.

FIG. 2 is a flow chart of a second embodiment of the method for accelerating intelligent terminal boot speed provided by the present invention. As shown in FIG. 2, the method according to the embodiment may include the following steps.

In step 201, a delay time is defined to delay the startup of a CPU hotplug algorithm during a flow of booting for performing a CPU (central processing unit, Central Processing Unit) algorithm.

A CPU algorithm processed by CPU Hotplug has to be adopted in the prior art; in this way, the CPU is under a few-core low frequency state during booting, so that the boot speed is slow.

In step 202, the running mode of the CPU is set as a performance mode, so that the CPU is under a highest frequency state and the CPU is under a multi-core state.

In the prior art, the CPU is under the few-core low frequency state all the time during running.

In step 203, a delay time is set for a boot startup script.

In step 204, the running mode of the CPU is switched to a normal mode when the defined delay time terminates, so that the CPU adjusts the CPU frequency according to a normal boot load.

In step 205, the time for delaying the boot of the CPU hotplug algorithm is calculated, so that the CPU dynamically adjusts the CPU frequency and the core number of the CPU according to a normal system load.

According to the embodiment, a problem of slow boot speed of a smartphone installed with an Android system is solved by delaying the CPU algorithm, adjusting and switching the CPU mode so that the CPU is under the highest frequency and multi-core state during the boot of the intelligent terminal.

Preferably, the defined delay time is 30 s.

Preferably, the delay time is 30 s.

The time in the table below includes the defined delay time and the delay time abovementioned, which is 60 s. To be specific, the defined delay time and the delay time may be defined according to specific settings. It is illustrated in the present invention by taking 30 s for example, but the time is not limited to this.

Through the algorithm alteration above, the comparison of the boot time before and after the CPU algorithm adjustment is as shown in the following table 1-comparison table of the boot time before and after the CPU algorithm adjustment:

TABLE 1
comparison table of the boot time before and
after the CPU algorithm adjustment

| | Boot time before the CPU | |
|---|---|---|
| Test | algorithm adjustment | Boot time after the CPU algorithm |
| times | (unit: s) | adjustment (unit: s) |
| 1 | 26.06 | 20.01 |
| 2 | 26.11 | 20.03 |
| 3 | 26.15 | 20.07 |
| 4 | 25.95 | 19.95 |
| 5 | 25.98 | 19.98 |
| Average | 26.05 | 20.01 |
| value | | |

It is found that the boot time may be improved by 6 s around by averaging the result of the five tests. The boot speed is improved by 23.2%.

To be specific, a micro code logic of the description in the foregoing method embodiment is as follows:

improving the CPU frequency and increasing the core number of the CPU based on CPU algorithm adjustment, so as to improve the boot speed, which may particularly include the following sub-steps:

(1) delaying a cpu hotplug algorithm for 60 s in code cpufreq_hotplug.c;

(2) selecting CONFIG_CPU_FREQ_GOV_PERFORMANCE in a configuration file, and setting the boot CPU mode as a performance mode;

(3) executing a startup script in an init.rc script during startup, delaying 30, then switching the CPU mode into a normal mode in echo interactive>/sys/devices/system/cpu/cpu0/cpufreq/scaling_governor; and

(4) respectively calculating the boot time before and after altering the CPU algorithm and averaging.

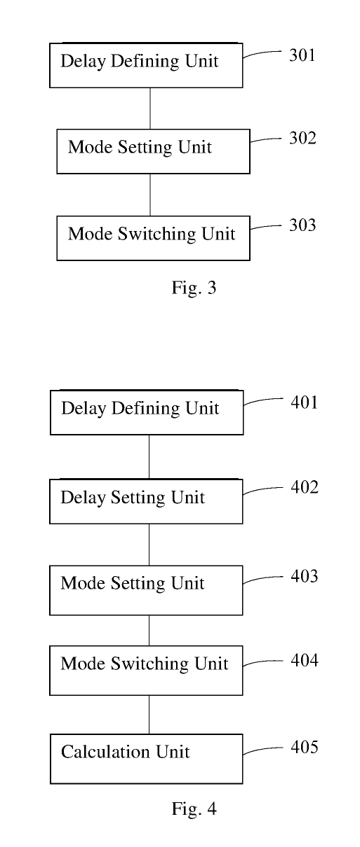

FIG. 3 is a structure diagram of a first embodiment of a system for accelerating intelligent terminal boot speed provided by the present invention. As shown in FIG. 3, the system according to the embodiment may include: a delay defining unit 301, a mode setting unit 302 and a mode switching unit 303, wherein:

the delay defining unit 301 is configured to define a delay time to delay the startup of a CPU hotplug algorithm during a flow of booting for performing a CPU algorithm; the mode setting unit 302 is configured to set a running mode of the CPU as a performance mode, so that the CPU is under a highest frequency state and the CPU is under a multi-core state; and the mode switching unit 303 is configured to switch the running mode of the CPU to a normal mode when the defined delay time terminates, so that the CPU adjusts the CPU frequency according to a normal boot load.

The device according to the embodiment may be configured to execute the technical solutions of the embodiment of the method as shown in FIG. 1, wherein the implementation principles and technical effects thereof are similar, and will not be elaborated herein. FIG. 4 is a structure diagram of a second embodiment of the system for accelerating intelligent terminal boot speed provided by the present invention. As shown in FIG. 4, the system according to the embodiment may include: a delay defining unit 401, a delay setting unit 402, a mode setting unit 403, a mode switching unit 404 and a calculation unit 405, wherein:

the delay defining unit 401 is configured to define a delay time to delay the startup of a CPU hotplug algorithm during a flow of booting for performing a CPU algorithm; the delay setting unit 402 is configured to set a delay time for a boot startup script; the mode setting unit 403 is configured to set a running mode of the CPU as a performance mode, so that the CPU is under a highest frequency state and the CPU is under a multi-core state; the mode switching unit 404 is configured to switch the running mode of the CPU to a normal mode when the defined delay time terminates, so that the CPU adjusts the CPU frequency according to a normal boot load; and the calculation unit 405 is configured to calculate the time for delaying the boot of the CPU hotplug algorithm, so that the CPU dynamically adjusts the CPU frequency and the core number of the CPU according to a normal system load.

The device according to the embodiment may be configured to execute the technical solutions of the embodiment of the method as shown in FIG. 2, wherein the implementation principles and technical effects thereof are similar, and will not be elaborated herein.

Based on the patent, improving the throughput of EMMC or nand and using a ubifs file system also belong to the application range of the patent, and can improve the intelligent terminal boot speed similarly.

It may be understood by those having ordinary skills in the art that the all or a part of steps of implementing the various embodiments of the method above may be finished through relevant hardware instructed by a program. The program may be stored in a mobile device or a computer readable storage medium, and the program while performing includes the steps of the foregoing embodiments of the method. While the forementioned storage medium includes: various mediums that can store program codes such as ROM, RAM, magnetic disk or optical disk.

The device embodiments described above are only exemplary, wherein the units illustrated as separation parts may either be or not physically separated, and the parts displayed by units may either be or not physical units, i.e., the parts may either be located in the same place, or be distributed on at least two network units. A part or all of the modules may be selected according to an actual requirement to achieve the objectives of the solutions in the embodiments. Those having ordinary skills in the art may understand and implement without going through creative work.

It should be finally noted that all the embodiments above are only configured to explain the technical solutions of the present invention, but are not intended to limit the protection scope of the present invention. Although the present invention has been illustrated in detail according to the foregoing embodiments, those having ordinary skills in the art should understand that modifications can still be made to the technical solutions recited in various embodiments described above, or equivalent substitutions can still be made to a part or whole of technical features thereof, and these modifications or substitutions will not make the essence of the corresponding technical solutions depart from the scope of the technical solutions of each embodiment of the present invention.

1. A method for accelerating intelligent terminal boot speed, comprising:
defining a delay time to delay the startup of a CPU hotplug algorithm during a flow of booting for performing a CPU (central processing unit, Central Processing Unit) algorithm;
setting a running mode of the CPU as a performance mode so that the CPU is under a highest frequency state and the CPU is under a multi-core state; and
switching the running mode of the CPU to a normal mode when the defined delay time terminates, so that the CPU adjusts the CPU frequency according to a normal boot load.

2. The method according to claim 1, further comprising:
calculating the time for delaying the boot of the CPU hotplug algorithm, so that the CPU dynamically adjusts the CPU frequency and the core number of the CPU according to a normal system load.

3. The method according to claim 1, wherein the method, before the switching the running mode of the CPU to the normal mode when the defined delay time terminates, so that the CPU adjusts the CPU frequency according to the normal boot load, further comprises:
setting a delay time for a boot startup script.

4. The method according to claim 1, wherein the defined delay time is 30 s.

5. The method according to claim 3, wherein the delay time is 30 s.

6. A system for accelerating intelligent terminal boot speed, comprising: a delay defining unit, a mode setting unit and a mode switching unit, wherein:
the delay defining unit is configured to define a delay time to delay the startup of a CPU hotplug algorithm during a flow of booting for performing a CPU algorithm;
the mode setting unit is configured to set a running mode of the CPU as a performance mode, so that the CPU is under a highest frequency state and under a multi-core state; and
the mode switching unit is configured to switch the running mode of the CPU to a normal mode when the defined delay time terminates, so that the CPU adjusts the CPU frequency according to a normal boot load.

7. The system according to claim 6, further comprising:
a calculation unit configured to calculate the time for delaying the boot of the CPU hotplug algorithm, so that the CPU dynamically adjusts the CPU frequency and the core number of the CPU according to a normal system load.

8. The system according to claim 6, wherein the system, before the mode setting unit, further comprises:
a delay setting unit configured to set a delay time for a boot startup script.

9. The system according to claim 6, wherein the defined delay time is 30 s.

10. The system according to claim 8, wherein the delay time is 30 s.

11. A system for accelerating intelligent terminal boot speed, comprising:
a processor; and
a memory for storing commands executed by the processor;
wherein the processor is configured to:
define a delay time to delay the startup of a CPU hotplug algorithm during a flow of booting for performing a CPU algorithm;
set a running mode of the CPU as a performance mode, so that the CPU is under a highest frequency state and under a multi-core state; and
switch the running mode of the CPU to a normal mode when the defined delay time terminates, so that the CPU adjusts the CPU frequency according to a normal boot load.

12. The system according to claim 11, wherein the processor is further configured to:
calculate the time for delaying the boot of the CPU hotplug algorithm, so that the CPU dynamically adjusts the CPU frequency and the core number of the CPU according to a normal system load.

13. The system according to claim 11, wherein before the switch the running mode of the CPU to the normal mode when the defined delay time terminates, so that the CPU adjusts the CPU frequency according to the normal boot load, the processor is further configured to:
set a delay time for a boot startup script.

14. The system according to claim 11, wherein the defined delay time is 30 s.

15. The system according to claim 13, wherein the delay time is 30 s.
